(19) United States
(12) Patent Application Publication
(10) Pub. No.: US 2019/0118017 A1
(43) Pub. Date: Apr. 25, 2019

(54) RHAMNOLIPID COATED NANOSCALE ZEROVALENT IRON EMULSIONS AND METHOD OF USE THEREOF

(71) Applicant: THE ROYAL INSTITUTION FOR THE ADVANCEMENT OF LEARNING UNIVERSITY, Montréal (CA)

(72) Inventors: Subhasis GHOSHAL, Verdun (CA); Sourjya BHATTACHARJEE, Montreal (CA)

(73) Assignees: THE ROYAL INSTITUTION FOR THE ADVANCEMENT OF LEARNING/MCGILL UNIVERSITY, Montréal, QC (CA); THE ROYAL INSTITUTION FOR THE ADVANCEMENT OF LEARNING/MCGILL UNIVERSITY, Montréal, QC (CA)

(21) Appl. No.: 16/093,274

(22) PCT Filed: Apr. 13, 2017
(86) PCT No.: PCT/CA2017/050462

§ 371 Date: Oct. 12, 2018

Related U.S. Application Data
(60) Provisional application No. 62/322,433, filed on Apr. 14, 2016.

(51) Int. Cl. A62D 3/37; C02F 1/70

(52) U.S. Cl. CPC A62D 3/37; A62D 2101/22; C02F 1/705

(57) ABSTRACT

The present disclosure relates to use of rhamnolipid coated nanoparticles of zero valent iron (NZVI), either in its bare form or functionalized with other materials (M) such as trace amounts of a palladium catalyst, for transforming chlorinated solvent pollutants by targeting the non-aqueous phase, which contains said chlorinated solvent pollutants. The method may be useful as water treatment technology for restoration of groundwater resources contaminated with toxic, chlorinated solvent pollutants as well as in the treatment of industrial waste of chlorinated solvents in reactor systems.

### CROSS REFERENCE TO RELATED APPLICATION

This application claims benefit of U.S. provisional application Ser. No. 62/322,433, filed 14 Apr. 2016.

### TECHNICAL FIELD

The present disclosure relates to nanoparticles of zero valent iron (NZVI) either in its bare form or functionalized with other materials (M) such as trace amounts of a palladium catalyst and the use of same for transforming chlorinated solvent pollutants. The method of use may therefore be useful as water treatment technology for restoration of groundwater resources contaminated with toxic, chlorinated solvent pollutants as well as in the treatment of industrial waste of chlorinated solvents in reactor systems.

### BACKGROUND ART

Nanoscale zerovalent iron (NZVI) can degrade chlorinated organic compounds, such as chlorinated solvents, including trichloroethylene (TCE), through reductive dechlorination reactions to ethane and other innocuous by-products. Pd⁰ deposited on the NZVI surface (Pd-NZVI) can enhance the rate of TCE degradation by acting as a hydrogenation catalyst and/or by shuttling electrons to TCE via the formation of a galvanic couple with Fe⁰. However, the major challenge in addressing chlorinated organic compound contamination in groundwater stems from its tendency to migrate deep into aquifers because it is denser than water (e.g. TCE density: 1.46 g/mL). Therefore, TCE non-aqueous phase liquid (NAPL) acts as a long-term source of contamination because of slow dissolution of TCE in the groundwater. In typical in situ remediation approaches, degradation of TCE is achieved only on the dissolved aqueous fraction of TCE, and the degradation of the TCE in the NAPL is limited by the rates of dissolution.

It would be more desirable to target and degrade the TCE NAPL, the source-zone for the groundwater contamination, because it contains the major mass fraction of the contaminant.

### SUMMARY

In accordance with the present disclosure there is now provided.

A process for degrading an amount of halogenated solvent by chemical reduction reactions in a non-aqueous phase liquid NAPL, comprising:

forming an oil in water emulsion of said halogenated solvent with an aqueous suspension comprising nanoscale zerovalent iron (NZVI) particle coated by a rhamnolipid (RL-NZVI), or NZVI functionalized with other materials (M) to improve its reactivity, such as palladium (Pd), and coated by a rhamnolipid (RL-M-NZVI) and a water-immiscible non-halogenated organic solvent; and
adding a water soluble, non-toxic salt thereby forming a water in oil emulsion and reacting said halogenated solvent and said RL-NZVI or RL-M-NZVI.

A process for degrading an amount of trichloroethene (TCE) by chemical reduction reactions in a non-aqueous phase liquid NAPL, comprising:

forming an oil in water emulsion of said TCE with an aqueous suspension comprising nanoscale zerovalent iron (NZVI) particle coated by a rhamnolipid (RL-NZVI), or NZVI functionalized with other materials (M) to improve its reactivity, such as palladium (Pd), and coated by a rhamnolipid (RL-M-NZVI) and a water-immiscible non-halogenated organic solvent; and
adding a water soluble, non-toxic salt thereby forming a water in oil emulsion and reacting said TCE and said RL-NZVI or RL-M-NZVI.

A process for degrading an amount of halogenated solvent by chemical reduction reactions in a non-aqueous phase liquid NAPL, comprising:

suspending a nanoscale zerovalent iron (NZVI) particle coated by a rhamnolipid (RL-NZVI), or a palladium doped nanoscale zerovalent iron (Pd-NZVI) particle coated by a rhamnolipid (RL-Pd-NZVI) in an aqueous medium of a system comprising a water-immiscible non-halogenated organic solvent and said aqueous medium;
forming an oil in water emulsion comprising said halogenated solvent, said RL-Pd-NZVI or RL-NZVI and water-immiscible non-halogenated organic solvent; and
adding a water soluble, non-toxic salt thereby forming a water in oil emulsion, and reducing said amount of halogenated solvent.

A process for degrading an amount of trichloroethene (TCE) by chemical reduction reactions in a non-aqueous phase liquid NAPL, comprising:

suspending a nanoscale zerovalent iron (NZVI) particle coated by a rhamnolipid (RL-NZVI), or NZVI functionalized with other materials (M) to improve its reactivity, such as palladium (Pd), and coated by a rhamnolipid (RL-M-NZVI) in an aqueous medium of a system comprising a water-immiscible non-halogenated organic solvent and said aqueous medium;
forming an oil in water emulsion comprising said TCE, said RL-M-NZVI or RL-NZVI and water-immiscible non-halogenated organic solvent; and
adding a water soluble, non-toxic salt thereby forming a water in oil emulsion, and reducing said amount of TCE.

A method for decreasing contamination in groundwater by a chlorinated solvent non-aqueous phase liquid (NAPL), comprising reacting a rhamnolipid coated palladium-doped nanoscale zerovalent iron (RL-Pd-NZVI) particle and said chlorinated solvent in a water in oil emulsion; wherein said water in oil emulsion is comprising a water-immiscible non-halogenated organic solvent.

A method for decreasing contamination in groundwater by a trichloroethene (TCE) non-aqueous phase liquid (NAPL), comprising reacting a rhamnolipid coated palladium-doped nanoscale zerovalent iron (RL-Pd-NZVI) particle and said TCE in a water in oil emulsion; wherein said water in oil emulsion is comprising a water-immiscible non-halogenated organic solvent.

A method for treating an industrial waste of chlorinated solvents in reactor systems, comprising reacting said industrial waste with a nanoscale zerovalent iron (NZVI) particle coated by a rhamnolipid (RL-NZVI) or a NZVI functionalized with other materials (M) to improve its reactivity, such as palladium (Pd), coated by a rhamnolipid (RL-M-NZVI), in a water in oil emulsion; wherein said water in oil emulsion is comprising a water-immiscible non-halogenated organic solvent.

A process for preparing a water in oil microemulsion comprising a chlorinated solvent and a rhamnolipid (RL) coated nanoscale zerovalent iron (RL-NZVI) or a NZVI functionalized with other materials (M) to improve its reactivity, such as palladium (Pd), coated by a rhamnolipid (RL-M-NZVI), said process comprising

providing an aqueous suspension of said rhamnolipid coated nanoscale zerovalent iron RL-NZVI or RL-M-NZVI;
mixing said suspension, said chlorinated solvent and a water-immiscible non-halogenated organic solvent to form an oil in water emulsion;
and adding a water soluble, non-toxic salt thereby forming a continuous organic phase consisting of said water in oil microemulsion.

A process for producing a doped nanoscale zerovalent iron particle coated with a rhamnolipid (RL-M-NZVI), the process comprising:

a) providing an aqueous dispersion of nanoscale zerovalent iron (NZVI);
b) contacting said dispersion of NZVI with a rhamnolipid (RL) to provide a rhamnolipid-coated nanoscale zerovalent iron (RL-NZVI); and
c) depositing a doping material (M), such as palladium (Pd), on said RL-NZVI of step b) to provide said RL-M-NZVI, provided that when said M of said RL-M-NZVI is palladium (Pd), said Pd, is at oxidation state zero (Pd⁰).

### BRIEF DESCRIPTION OF THE DRAWINGS

Reference will now be made to the accompanying drawings.

FIG. 1A illustrates a TEM image of nanoscale zerovalent iron (NZVI).

FIG. 1B illustrates the chemical structure of an example of mono- and di-rhamnolipid.

FIGS. 2A-C illustrates the phase transfer process, wherein in FIG. 2A TCE is found settled as a pure NAPL phase at the bottom of the vial while RL-Pd-NZVI is in the aqueous phase; in FIG. 2B, formation of an emulsion after sonication is seen; and in FIG. 2C phase-transferred RL-Pd-NZVI after NaCl addition is observed.

FIGS. 3A-D illustrates the composition by weight percent showing in FIG. 3A organic (butanol/TCE) phase excluding Pd-NZVI; in FIG. 3B aqueous phase excluding Pd-NZVI; FIG. 3C an optical microscopy image of the organic phase at 10× magnification; and in FIG. 3D an optical microscopy image of organic phase at 60× magnification.

FIG. 4 illustrates the distribution of each component between the aqueous and organic phases.

FIG. 5A illustrates a schematic of two reactors used to assess TCE degradation.

FIG. 5B illustrates the TCE degradation profile with time in aqueous and organic mixtures.

FIG. 6 illustrates the headspace TCE concentrations in aqueous and organic mixtures measured over the duration of TCE degradation experiments.

FIG. 7 illustrates TEM images in FIG. 7A of unreacted RL-Pd-NZVI; in FIG. 7B of RL-Pd-NZVI in the aqueous mixture after reaction with TCE; and in FIG. 7C of RL-Pd-NZVI in the organic solvent mixture after reaction with TCE.

FIG. 8 illustrates EDS of spot A shown in TEM image of isolated unreacted RL-Pd-NZVI (right hand image), wherein Si and Cu peaks originate from the TEM grid, and wherein spot analysis shows presence of Fe, O and Pd.

FIG. 9 illustrates EDS of spot A shown in TEM image of unreacted RL-Pd-NZVI shows strong oxygen peaks, suggesting the presence of oxidized Fe.

FIG. 10 illustrates EDS of spot A shown in TEM image of RL-Pd-NZVI in SYSTEM A.

FIG. 11 illustrates EDS of spots A, B, & C shown in TEM image of RL-Pd-NZVI in the organic solvent mixture, wherein EDS of spot A reveals strong peaks for palladium.

FIGS. 12A-C illustrates Fe 2p_{3/2} XPS spectra in FIG. 12A of unreacted RL-Pd-NZVI; in FIG. 12B RL-Pd-NZVI in the aqueous mixture after reaction with TCE; and FIG. 12C RL-Pd-NZVI in the organic solvent mixture after reaction with TCE.

FIG. 13 illustrates the end products generated at the end of TCE degradation in aqueous and organic mixtures.

FIG. 14 illustrates the TCE degradation profile with time in aqueous and organic mixtures.

### DETAILED DESCRIPTION

There is provided a new nanotechnology-based approach for transforming chlorinated solvent pollutants into non-toxic components. This may therefore be useful in water treatment processes for water resources contaminated with carcinogenic, chlorinated pollutants such as trichloroethene (TCE).

Nanoparticles of zero valent iron (NZVI) or NZVI functionalized with other materials such as trace amounts of a palladium catalyst (Pd-NZVI) are very reactive for degrading TCE. However, this disclosure provides an approach that enables the NZVI or Pd-NZVI to migrate in to the TCE solvent (oil) phase with the aid of a rhamnolipid coating and a water-immiscible, non-halogenated organic solvent (preferably a biodegradable solvent), resulting in an increase in treatment efficiencies of TCE.

Palladium-doped nanoscale zerovalent iron (Pd-NZVI) has been shown to degrade environmental contaminants such as trichloroethylene (TCE) to benign end-products through aqueous phase reactions. It is shown herein that rhamnolipids-coated NZVI (RL-NZVI), or a NZVI functionalized with other materials (M) to improve its reactivity, such as palladium (Pd), coated by a rhamnolipid (RL-M-NZVI) when reacted with TCE in a biodegradable and water-immiscible non-halogenated organic solvent results in more TCE mass degraded per unit mass of Pd-NZVI, with an increased degradation rate.

In one embodiment, the water-immiscible non-halogenated organic solvent is a biodegradable solvent.

In one embodiment, the water-immiscible non-halogenated organic solvent is n-butanol, ethyl acetate, pentanol, hexanol or octanol.

In one embodiment, the water-immiscible non-halogenated organic solvent is n-butanol, pentanol, hexanol or octanol.

In one embodiment, the water-immiscible non-halogenated organic solvent is a mixture of two or more of n-butanol, ethyl acetate, pentanol, hexanol or octanol.

In one embodiment, the water-immiscible non-halogenated organic solvent is n-butanol, ethyl acetate, pentanol, hexanol or octanol or a mixture thereof.

In one embodiment, the water-immiscible non-halogenated organic solvent is n-butanol.

In one embodiment, the amount of palladium doping said nanoscale zerovalent iron (Pd-NZVI) is from 0.1% to 1% wt./wt.

In one embodiment, the rhamnolipid for use in coating the NZVI particles are a single rhamnolipid or a mixture of two or more rhamnolipids.

In one embodiment of the process for producing a RL-Pd-NZVI, the wt./wt ratio of said rhamnolipid or a mixture of two or more rhamnolipids (on a Total Organic Carbon (TOC) basis) to said NZVI, is from about 0.05 to 20 (or also expressed as 5 to 2000%.

As used herein, rhamnolipid(s) (RL) can be illustrated by description as follows: they are glycosides composed of one or more (preferably up to two) rhamnose moieties (glycon), and one or more (preferably up to two) β-hydroxy fatty acid moieties (aglycon). The glycon and aglycon are linked via a O-glycosidic linkage. When RL is composed of two rhamnoses, they are linked to each other through a α-1,2-glycosidic linkage. The β-hydroxy fatty acid chains are saturated, mono-, or poly-unsaturated and of chain length varying from C₈ to C₁₆ and (when two are present) are linked to each by an ester bond formed between the β-hydroxyl group of the distal (relative to glycosidic bond) β-hydroxy fatty acid with the carboxyl group of the proximal β-hydroxy fatty acid as illustrated below:

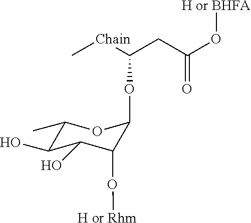

As used above, “chain” reflects the residue of the β-hydroxy fatty acid, “BHFA” means β-hydroxy fatty acid and “Rhm” means rhamnose.

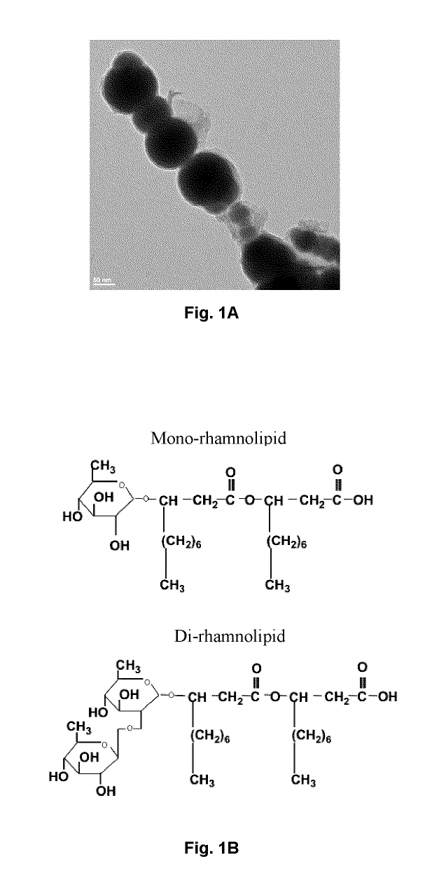

In one embodiment, the rhamnolipid for use in coating the Pd-NZVI particles is a mixture of 2-O-rhamnopyranosyl-rhamnopyranosyl-3-hydroxyldecanoyl-3-hydroxydecanoate and rhamnopyranosyl-3-hydroxyldecanoyl-3-hydroxydecanoate (as illustrated in FIG. 1); 2-O-rhamnopyranosyl-rhamnopyranosyl-3-hydroxyldecanoyl-3-hydroxydecanoate or rhamnopyranosyl-3-hydroxyldecanoyl-3-hydroxydecanoate may be used individually.

RL-NZVI, or RL-M-NZVI (such as RL-Pd-NZVI) are preferentially suspended in water in biphasic organic liquid-water systems and, as demonstrated herein for the first time, their rapid phase transfer can be achieved by transporting NZVI (such as Pd-NZVI) by creating water-in-oil emulsions in the organic phase (in the examples herein by mixing butanol/TCE) by addition of a salt (in the examples below NaCl).

In one embodiment, the salt that may be used for effecting a phase transfer of RL-NZVI, or RL-M-NZVI (such as RL-Pd-NZVI) may be water soluble, non-toxic salts such as monovalent and divalent salts. Examples include NaCl, Na₂CO₃, CaCl₂, or MgCl₂.

In one embodiment, the salt that may be used for effecting a phase transfer of RL-NZVI, or RL-M-NZVI (such as RL-Pd-NZVI) may be water soluble, non-toxic salts such as monovalent and divalent salts. Examples include NaCl, CaCl₂, or MgCl₂.

For greater clarity, the metallic species (M or for example Pd) once deposited on the nanoparticles to form RL-M-NZVI (or RL-Pd-NZVI) is at oxidation state zero (such as Pd⁰). In the process preparing said nanoscale zerovalent iron particle coated with a rhamnolipid (RL-M-NZVI), in particular RL-Pd-NZVI, a precursor compound (such as Pd(OAc)2) may be used with said RL-NZVI, which is then deposited as reduced Pd(0). Also, “functionalized with other materials (M)” may be used interchangeably with “doped” with other materials (M)” and refers to the addition of a catalyst such as Pd⁰ deposited on the NZVI surface to enhance the rate of halogenated/chlorinated solvent (such as TCE or PCE) degradation by acting as a hydrogenation catalyst and/or by shuttling electrons to the solvent via the formation of a galvanic couple with Fe⁰.

In one embodiment, the halogenated/chlorinated solvent is perchloroethene (PCE) or trichloroethene (TCE). In one embodiment, the halogenated/chlorinated solvent is PCE. In one embodiment, the halogenated/chlorinated solvent is TCE.

In one embodiment of any one of the process for degrading an amount of halogenated solvent or degrading an amount of trichloroethene (TCE) or the method for decreasing contamination in groundwater by a chlorinated solvent or the method for decreasing contamination in groundwater by trichloroethene (TCE) or the method for treating an industrial waste or the process for preparing a water in oil microemulsion as defined herein, said halogenated solvent is perchloroethene (PCE) or trichloroethene (TCE), said rhamnolipid is a 2-O-rhamnopyranosyl-rhamnopyranosyl-3-hydroxyldecanoyl-3-hydroxydecanoate and/or rhamnopyranosyl-3-hydroxyldecanoyl-3-hydroxydecanoate, said particle is RL-Pd-NZVI, material (M) is palladium (Pd⁰), said water-immiscible non-halogenated organic solvent is n-butanol, ethyl acetate, pentanol, hexanol or octanol, said water soluble, non-toxic salt is NaCl, Na₂CO₃, CaCl₂, or MgCl₂.

In one embodiment of any one of the process for degrading an amount of halogenated solvent or degrading an amount of trichloroethene (TCE) or the method for decreasing contamination in groundwater by a chlorinated solvent or the method for decreasing contamination in groundwater by a trichloroethene (TCE) or the method for treating an industrial waste or the process for preparing a water in oil microemulsion as defined herein, said halogenated solvent is TCE, said rhamnolipid is a 2-O-rhamnopyranosyl-rhamnopyranosyl-3-hydroxyldecanoyl-3-hydroxydecanoate and/or rhamnopyranosyl-3-hydroxyldecanoyl-3-hydroxydecanoate, said particle is RL-Pd-NZVI, said particle is RL-Pd-NZVI, material (M) is palladium (Pd⁰), said water-immiscible non-halogenated organic solvent is n-butanol, ethyl acetate, pentanol, hexanol or octanol, said water soluble, non-toxic salt is NaCl, Na₂CO₃, CaCl₂, or MgCl₂.

In one embodiment of any one of the process for degrading an amount of halogenated solvent or degrading an amount of trichloroethene (TCE) or the method for decreasing contamination in groundwater by a chlorinated solvent or the method for decreasing contamination in groundwater by a trichloroethene (TCE) or the method for treating an industrial waste or the process for preparing a water in oil microemulsion as defined herein, said halogenated solvent is TCE, said rhamnolipid is a 2-O-rhamnopyranosyl-rhamnopyranosyl-3-hydroxyldecanoyl-3-hydroxydecanoate and/or rhamnopyranosyl-3-hydroxyldecanoyl-3-hydroxydecanoate, said particle is RL-Pd-NZVI, said particle is RL-Pd-NZVI, material (M) is palladium (Pd⁰), said water-immiscible non-halogenated organic solvent is n-butanol, pentanol, hexanol or octanol, said water soluble, non-toxic salt is NaCl, CaCl₂, or MgCl₂.

In one embodiment of any one of the process for degrading an amount of halogenated solvent or degrading an amount of trichloroethene (TCE) or the method for decreasing contamination in groundwater by a chlorinated solvent or the method for decreasing contamination in groundwater by a trichloroethene (TCE) or the method for treating an industrial waste or the process for preparing a water in oil microemulsion as defined herein, said halogenated solvent is TCE, said rhamnolipid is a 2-O-rhamnopyranosyl-rhamnopyranosyl-3-hydroxyldecanoyl-3-hydroxydecanoate and rhamnopyranosyl-3-hydroxyldecanoyl-3-hydroxydecanoate, said particle is RL-Pd-NZVI, material (M) is palladium (Pd⁰), said water-immiscible non-halogenated organic solvent is n-Butanol, said water soluble, non-toxic salt is NaCl.

In one embodiment of any one of the process for degrading an amount of halogenated solvent or degrading an amount of trichloroethene (TCE) or the method for decreasing contamination in groundwater by a chlorinated solvent or the method for decreasing contamination in groundwater by a trichloroethene (TCE) or the method for treating an industrial waste or the process for preparing a water in oil microemulsion as defined herein, the mass ratio of said adsorbed rhamnolipid (RL) on said NZVI, is from about 0.05 to 20.

In one embodiment, the process for producing a Pd doped nanoscale zerovalent iron particle coated with a rhamnolipid (RL-Pd-NZVI) is comprising:

a) providing an aqueous dispersion of NZVI;
b) contacting said dispersion of NZVI with a 2-O-rhamnopyranosyl-rhamnopyranosyl-3-hydroxyldecanoyl-3-hydroxydecanoate and rhamnopyranosyl-3-hydroxyldecanoyl-3-hydroxydecanoate (RL) to provide a rhamnolipid-coated nanoscale zerovalent iron (RL-NZVI); and
c) adding an alcoholic (such as ethanolic) solution of a palladium compound (such as Pd-Acetate) to said RL-NZVI of step b) to provide said RL-Pd-NZVI wherein said Pd is Pd⁰.

It is believed that the significant enhancement in reactivity is caused by a higher electron release (3e⁻ per mole of Fe⁰) from Pd-NZVI in the butanol phase compared to the same reaction with TCE in the aqueous phase (2e⁻ per mole of Fe⁰). XPS characterization studies of Pd-NZVI show Fe⁰ oxidation to Fe(III) oxides for Pd-NZVI reacted with TCE in the organic butanol phase compared to Fe(II) oxides in the aqueous phase, which accounted for differences in the TCE reactivity extents and rates observed in the two phases. Accordingly, improved remediation efficiency is achieved by reacting Pd-NZVI in the organic phase and that such phase transfer strategies are beneficial in the design of more efficient treatment systems.

An impediment to achieving direct degradation of the TCE in the NAPL using Pd-NZVI is the preferential solubility of the nanoparticles in the aqueous phase which prevents their migration into the NAPL phase.

As described herein, a tertiary organic phase was employed which is miscible with TCE NAPL, to enable a coated Pd-NZVI to interact with TCE NAPL through a phase transfer process. For instance, it is demonstrated in the examples below a 50% increase in the amount of TCE NAPL degraded by phase transferred Pd-NZVI in the organic phase compared to TCE degradation in the aqueous phase.

NZVI particles were synthesized through the reduction of Fe²⁺ precursor with sodium borohydride in an aqueous phase. As seen in the TEM image in FIG. 1A, they were spherical particles in the 20-100 nm size range arranged in chain like aggregates and a BET surface area of 25 m²/g. The NZVI particles were then equilibrated with a rhamnolipid (RL) overnight and complete sorption of RL to NZVI was observed. The RL employed herein consisted of a mixture of mono- and di-rhamnolipid as shown in FIG. 1B. Thereafter palladium acetate was added to the RL-NZVI to deposit Pd⁰ (0.5% w/w NZVI) on NZVI surface resulting in the RL-Pd-NZVI particles.

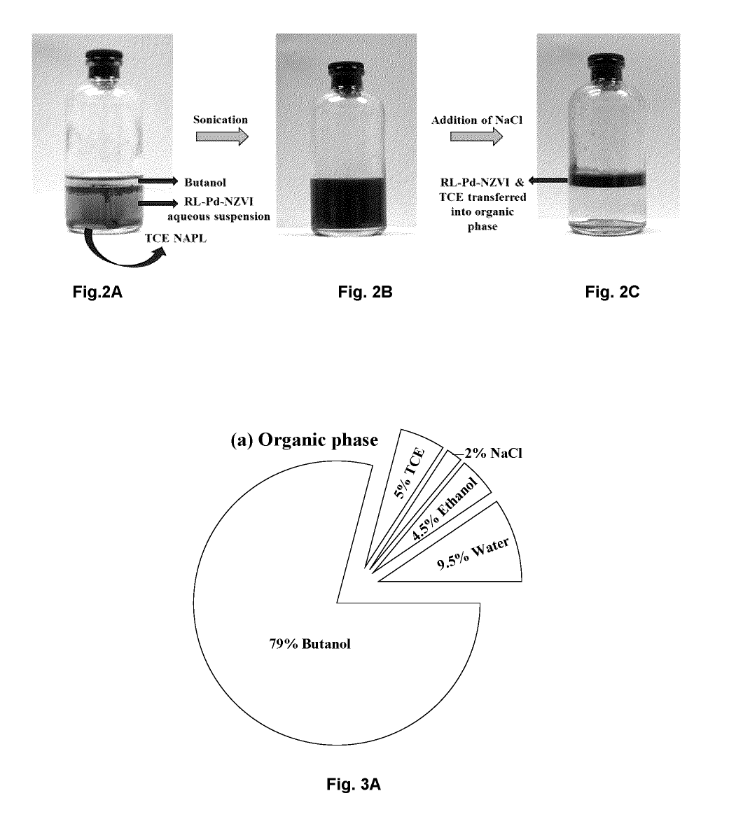

The phase transfer of RL-NZVI, or RL-M-NZVI (such as RL-Pd-NZVI) can be facilitated using butanol and NaCl as follows. An aqueous suspension of RL-Pd-NZVI was sonicated in the presence of TCE NAPL and butanol (FIG. 2A) which resulted in the formation of stable emulsions of TCE (oil in water microemulsion) (FIG. 2B). Subsequent addition of NaCl decreased the ionic interactions of RL with water due to charge screening (reduction of Debye length). This resulted in the Winsor I-III-II transition, which led to the formation of a continuous organic phase consisting of a water in oil microemulsion and an excess aqueous phase. RL was bound to Pd-NZVI through carbon/late functional groups and caused the simultaneous transfer of the nanoparticles into the organic phase upon NaCl addition (FIG. 2C).

The phase-transferred RL-Pd-NZVI in the examples below were extremely stable in the organic phase, and destabilization of the nanoparticles has not been observed (even after completion of degradation reactions) in systems kept quiescent for over 1.5 years. Butanol was used to facilitate the phase transfer based on its history of implementation for TCE remediation by TCE mobilization or by bioremediation. Butanol can be delivered in the subsurface effectively and has as advantage that it is miscible with TCE NAPL, and has low solubility in water. Emulsification of water in the butanol/TCE phase can be achieved in the subsurface by the shear forces generated by fluid flow through porous media.

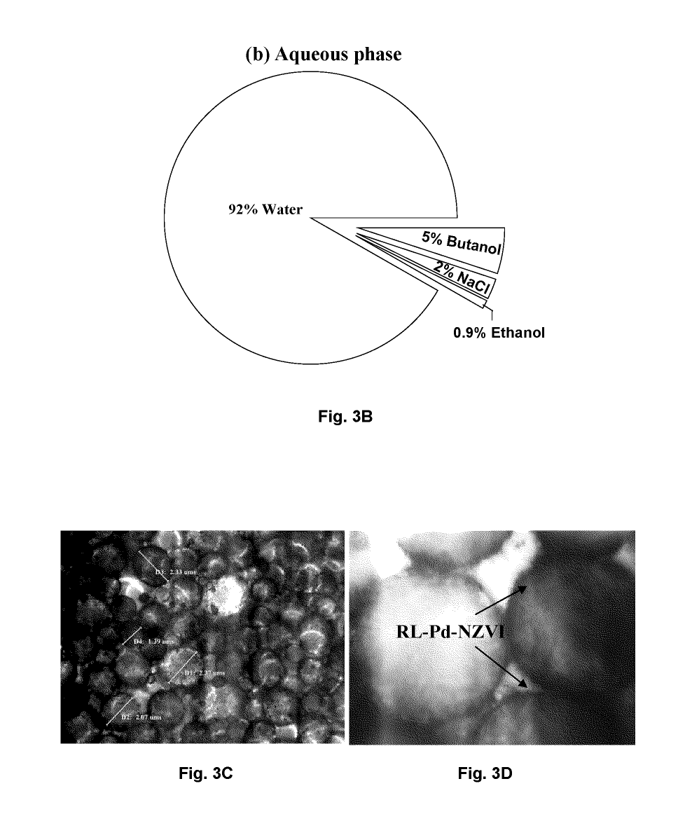

The composition of the aqueous and organic phases after the phase transfer process was characterized and is shown in FIG. 3. The characterization of the phases was carried out in the absence of Pd-NZVI to avoid rapid degradation losses of TCE, and in the absence of any headspace to avoid partitioning losses of volatile components. Ethanol is present during the Pd-NZVI synthesis procedure and therefore was also incorporated in the component analysis.

As seen in FIG. 3A, the organic phase is primarily made up of butanol (79% by weight) and consists of 5% TCE by weight. Some fraction of NaCl is also present within the organic phase. The aqueous phase, as expected, largely consists of water (a weight basis break-up of the components is provided in Table 1).

TABLE 1
Composition of organic and aqueous phase on weight basis

| | Organic phase | | Aqueous phase | |
|---|---|---|---|---|
| | Weight (g) | | Weight (g) | |
| Component | Average | std. dev. | Average | std. dev. |
| Water | 2.400E−01 | 1.000E−02 | 1.942E+01 | 7.238E−02 |
| Ethanol | 1.126E−01 | 2.887E−02 | 1.959E−01 | 2.832E−02 |
| NaCl | 4.579E−02 | 2.716E−03 | 4.792E−01 | 2.716E−03 |
| TCE | 1.285E−01 | 4.948E−03 | 5.354E−03 | 1.843E−04 |
| Butanol | 1.986E+00 | 1.546E−01 | 1.070E+00 | 1.732E−01 |
| Total | 2.513E+00 | 1.315E−01 | 2.117E+01 | 9.762E−02 |

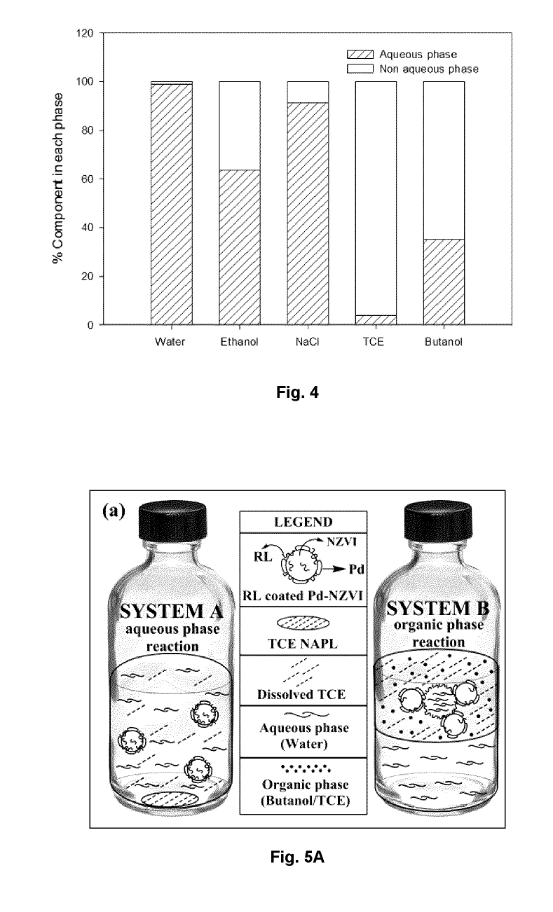

On a weight basis, 96% of the initial TCE mass added to the vial migrated into the organic phase (FIG. 4). RL was assumed to be completely in the organic phase due to its role in emulsification. Additionally, RL (due to its dark brown color) was visually observed to accumulate in the organic phase.

The organic phase was also characterized under a microscope (Olympus BX51) to visually determine the water in oil emulsion formation and location of nanoparticles. In FIG. 3C (image taken under 10× magnification), the formation of emulsion droplets with an average size of 2 μm can be clearly seen. All droplets have dark edges due to the presence of Pd-NZVI. A 60× magnification allows us to observe the location of RL-Pd-NZVI as shown in FIG. 3D. As is seen, the droplet is surrounded by dark particles which can be attributed to the aggregated RL-Pd-NZVI particles.

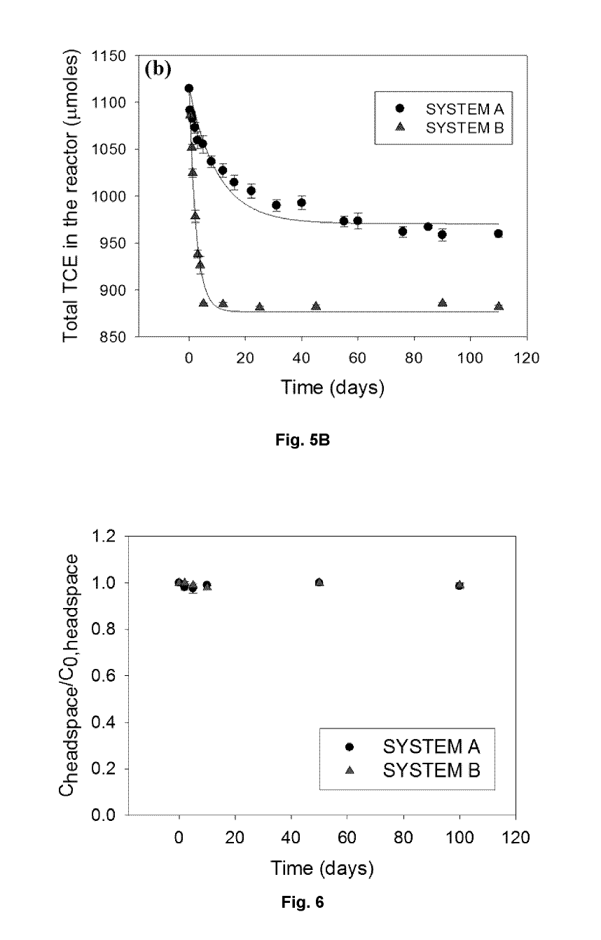

The key feature that must be preserved when RL-Pd-NZVI are transferred into the organic phase is their reactive functionality for TCE NAPL degradation. To this end, the TCE degradation rate and extent was evaluated by RL-Pd-NZVI in the aqueous phase, and compared with the phase transferred system. The two batch reactors are schematically shown in FIG. 5a and are explained below:

1—SYSTEM A (aqueous phase reactions): SYSTEM A consists of an aqueous suspension of RL-Pd-NZVI saturated with dissolved TCE (8.4 mM TCE), in equilibrium with a TCE NAPL. This represents a system where Pd-NZVI reactions occur solely in the aqueous phase.
2—SYSTEM B (organic phase reactions): SYSTEM B consists of a TCE NAPL which is completely dissolved in the organic phase into which the RL-Pd-NZVI are phase transferred.

In both SYSTEMS A and B, RL-Pd-NZVI is in contact with stoichiometrically excess amounts of TCE throughout the duration of the degradation experiments (FIG. 6). Therefore the TCE degradation rate in both systems can be attributed solely to the reaction kinetics at the RL-Pd-NZVI surface rather than any mass transfer limitations due to slow dissolution rates from the NAPL.

Degradation of TCE by RL-Pd-NZVI can be represented using the following half reactions:

Fe⁰→Fe²⁺+2e⁻ (1)

Fe²⁺→Fe³⁺+e⁻ (2)

TCE+x.e+y.H⁺→products+zCl⁻ (3)

In equations 1 and 2, it is shown that Fe⁰ may yield 2 or 3 electrons, while in equation 3, x represents the stoichiometric amount of electrons required for TCE dechlorination.

The profile for TCE degradation by RL-Pd-NZVI in the aqueous phase (SYSTEM A) and in the organic phase (SYSTEM B) are shown in FIG. 5B, and the reaction rates and extents are quantified and presented in Table 2.

TABLE 2
TCE degradation extent and rates by RL-Pd-NZVI in
SYSTEMS A and B

| | TCE | TCE degradation | |
|---|---|---|---|
| | degraded | rate | |
| System | (μmoles) | K_{obs} (day⁻¹) | r² |
| A | 156 ± 4 | 0.099 ± 0.017 | 0.92 |
| (aqueous | | | |
| phase | | | |
| reaction) | | | |
| B | 232 ± 5 | 0.413 ± 0.046 | 0.98 |
| (organic | | | |
| phase | | | |
| reaction) | | | |

The TCE degradation profile was best fitted with a pseudo-first-order rate equation (equation 4) using the curve fitting tool in MATLAB (Release 2013b, The MathWorks Inc.)

Mₜ=Mₑ+(M₀−Mₑ)e^{-k}^{_{obs}}^{t} (4)

where, Mₜ is the mass of TCE in the reactor, and k_{obs} is the observed pseudo first order TCE degradation rate constant (day⁻¹). The study employed stoichiometric limited amounts of Pd-NZVI compared to TCE. Therefore, the equation incorporates stoichiometric endpoints in the form of Mₑ in the rate calculations.

As is evident from FIG. 5B and Table 2, the TCE degradation rate (k_{obs}) and extent was significantly improved in the organic phase (SYSTEM B) as compared to the aqueous phase (SYSTEM A) with a 4 fold faster dechlorination rate and degradation of nearly 50% higher TCE mass. The RL-Pd-NZVI particles employed in both systems were identical. Previously it was reported that presence of free RL in solution can affect the TCE degradation rate and extent by coating the exposed Pd sites (Bhattacharjee, S.; et al Effects of rhamnolipid and carboxymethylcellulose coatings on reactivity of palladium-doped nanoscale zerovalent iron particles. Environ. Sci. Technol. 2016, 50 pp 1812-1820). However, in the present experimentation no free RL existed in solution which could potentially affect the TCE degradation rate or extent.

Thus in order to probe the differences arising in the reactivity characteristics, we recovered the nanoparticles from both systems (SYSTEM A & B) at the end of their reactive lifetime and conducted TEM as well as XPS analysis to gain insight into the changes brought about in the particle morphology and surface chemistry.

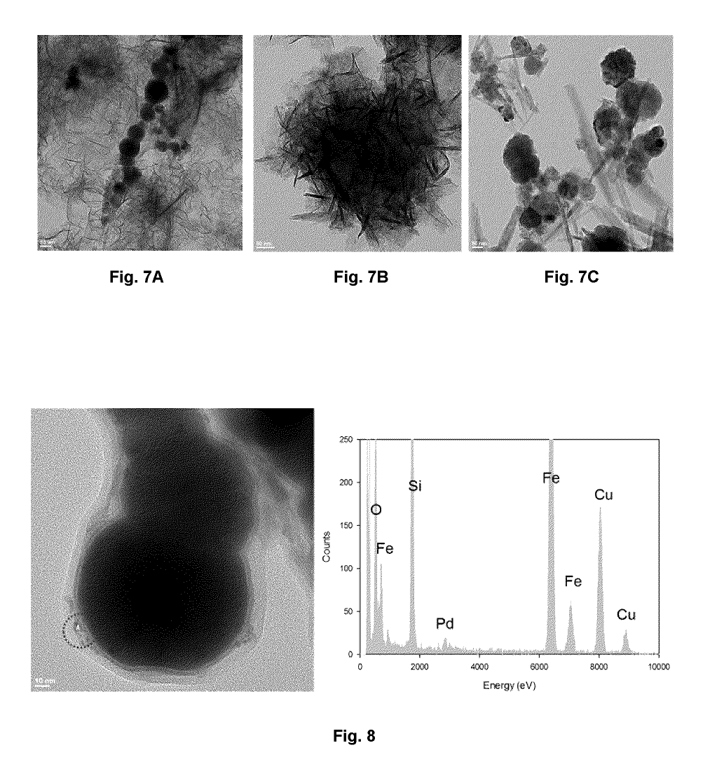

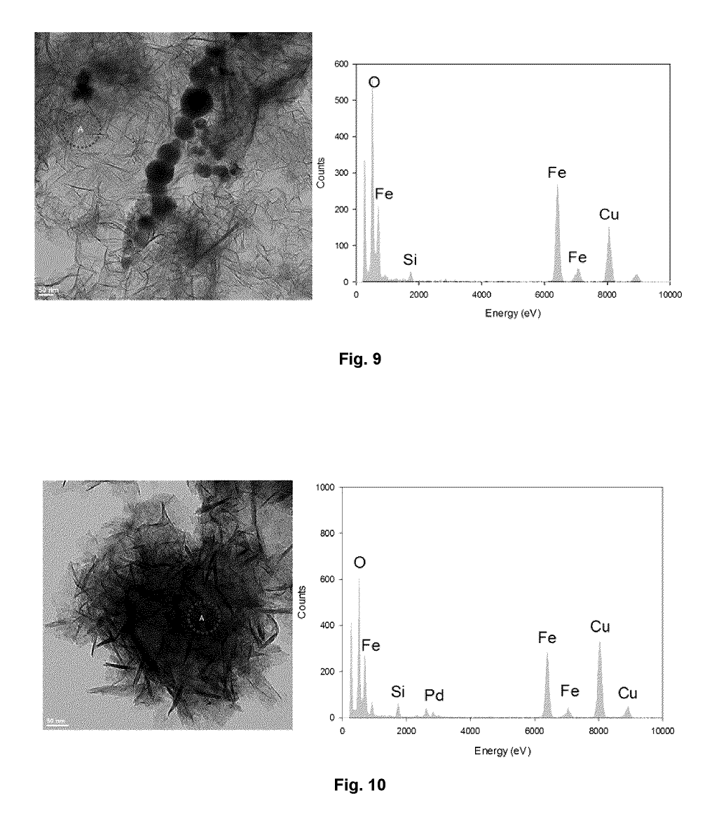

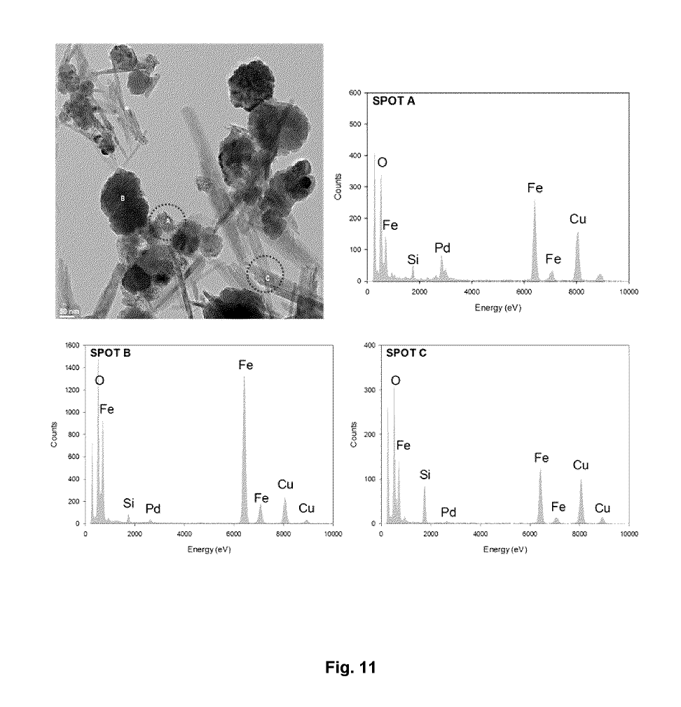

FIG. 7A shows that before reaction, RL-Pd-NZVI were made up of spherical particles between 20-100 nm arranged as chains with Pd deposits on the surface (FIG. 8). The nanoparticles appear partially oxidized (confirmed through EDS shown in FIG. 9), which can be attributed to the reaction of NZVI with water during the overnight mixing process with RL. After having undergone reaction with TCE in the aqueous phase, RL-Pd-NZVI in SYSTEM A do not appear as distinct particles but rather as small needle-like clusters (FIG. 7B). EDS on the particles (FIG. 10) suggest the formation of iron oxides, which as seen in the TEM image are packed closely together. In contrast, RL-Pd-NZVI particles extracted after reaction with TCE in the organic phase in SYSTEM B (FIG. 7C) have a coarse structure, and a hollowed-out core can be observed for some particles as well. EDS on the hollowed-out particles showed a strong peak for Pd (FIG. 11). This is consistent with previous reports where reaction of Pd-NZVI with water resulted in the outward diffusion of Fe ions creating a hollowed-out structure, while Pd⁰ migrated progressively inwards. Acicular particles are also observed in FIG. 7C which are typically the structure for lepidocrocite.

Low resolution survey scans for unreacted RL-Pd-NZVI showed the presence of Fe, O, and Pd while those for RL-Pd-NZVI in SYSTEMS A and B yielded peaks for Fe, O, Pd, and Cl (Table 3).

TABLE 3
Relative atomic abundance from XPS

| | | | Relative atomic % | | |
|---|---|---|---|---|---|
| | | | RL-Pd-NZVI | SYSTEM | SYSTEM |
| Name | B.E. | Identification | unreacted | A | B |
| Cl2p3/2 | 198.5 | Cl-Metal | — | 1.3 | 2 |
| Pd3d5/2 | 335.9 | *Pd⁰ | 0.2 | 0.1 | 0.1 |
| O1s | 530.2 | O₂⁻ | 23.6 | 9.8 | 20.6 |
| | 531.5 | OH⁻ | 25.5 | 19.3 | 20 |
| Fe2p3/2 | 707.2 | Fe⁰ | 0.7 | — | — |
| | 709.6 | Fe²⁺ | — | 3.4 | — |
| | 710.9 | Fe³⁺ (Fe₂O₃) | — | 3.9 | 12.4 |
| | 711.3 | | 14.5 | — | — |
| | 713.5 | Fe³⁺ (Fe(OH)₃, | — | 2.1 | 3.8 |
| | 714.4 | FeOOH) | 4.5 | — | — |
| | 717.3 | Fe²⁺ shake up | — | 0.9 | — |
| | 718 | Fe³⁺ shake up | — | — | 4.7 |
| | 719.2 | | 9.2 | — | — |

*detected just above the detection limit which is around 0.1%. The binding energy (B.E.) of Pd detected is very close to the range of B.E. where metallic Pd is expected. Metallic Pd is expected at BE between 334.1 eV and 335.8 eV

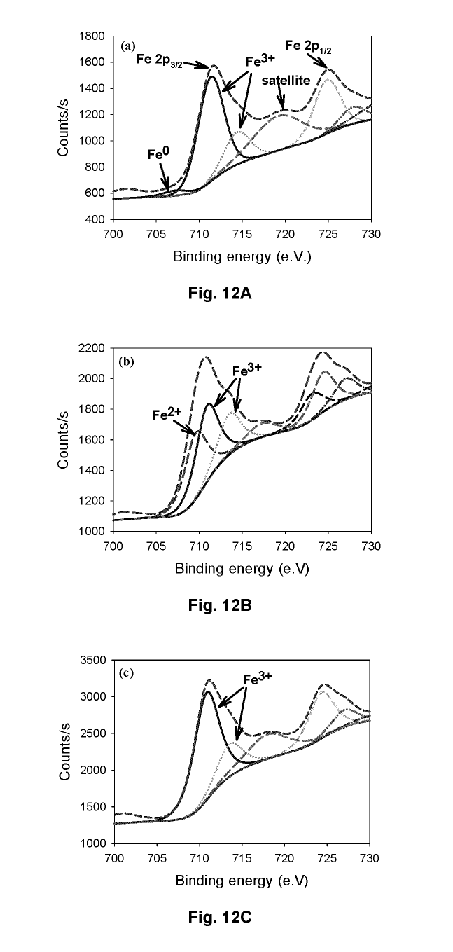

High resolution scan for the Fe 2p_{3/2} XPS spectra for unreacted RL-Pd-NZVI particles is shown in FIG. 12A. The deconvoluted peaks at 711.3 eV and 714.4 eV reveal that the surface of unreacted RL-Pd-NZVI primarily consists of Fe(III) oxides and hydroxides (Fe₂O₃ & FeOOH) with a contribution of zerovalent iron (Fe⁰) seen at 707.2 eV. This is in agreement with the typical structure of zero-valent iron consisting of a Fe⁰ core and a shell of iron oxides and hydroxides. After undergoing reaction with TCE in the organic phase, particle surfaces in SYSTEM B (FIG. 12C) did not show a considerable difference in the oxidation states, except for the disappearance of Fe⁰. However for nanoparticles exposed to TCE in the aqueous phase (SYSTEM A), a new peak corresponding to Fe(II) oxide (FeO) appeared around 709.6 eV. The relative intensity of the Fe³⁺ peaks were also lower. Accordingly, iron particles in aqueous phase (SYSTEM A) primarily transformed into oxides in the +2 oxidation state during reaction with TCE, while those in the organic phase (SYSTEM B) oxidized to the +3 state only. This was in qualitative agreement with the different morphological characteristics of iron oxides seen in TEM images (FIGS. 7B and 7C).

The implications of these differences in the surface chemistry of Pd-NZVI nanoparticles in the aqueous and organic phases is observed most clearly when comparing the extents of degradation achieved in these phases. TCE degraded in the organic phase was 230 μmoles, while that in the aqueous phase was 156 μmoles (Table 2). Given that NZVI was stoichiometrically in excess relative to TCE, the difference in the amounts degraded can only be explained by differences in the number of electrons available. The higher moles of TCE degraded per mole of Pd-NZVI in the organic phase is due to the release of 3 electrons from the nanoparticles compared to the release of 2 electrons in the aqueous phase. To verify whether the lower extent of TCE degradation by RL-Pd-NZVI in the aqueous phase (SYSTEM A) was due to lack of Fe⁰ oxidation, the particles were extracted and acid digested after the TCE degradation reaction. The liberated H₂ was used to estimate the moles of Fe⁰ remaining (Liu, Y.; et al. Environ. Sci. Technol. 2005, 39, 1338-1345).

As can be seen in Table 4, less than 1% of the initial Fe⁰ remained unused in both systems. Moreover, an electron balance using a 2e⁻ conversion scheme for SYSTEM A (Fe⁰→Fe²⁺+2e⁻), and 3e⁻ conversion scheme for SYSTEM B (Fe⁰→Fe³⁺+3e⁻) yielded nearly 90% balance.

TABLE 4
Electron balance in SYSTEM A & B

| | | e⁻ used | | |
|---|---|---|---|---|
| | | for TCE | Unused Fe⁰† | |
| System | Initial e⁻ | reduction* | (μmol) | % e⁻ balance |
| A | 1144 | 987 (±30) | 5 | 87 ± 2% (2e⁻ basis) |
| B | 1716 | 1562 (±20) | 3 | 91 ± 1% (3e⁻ basis) |

*calculated from liberated end products
†calculated from acid digestion; Initial moles of Fe⁰ in unreacted Pd-NZVI = 572 μmol Fe⁰

A plausible explanation for the differences observed in the iron oxidation may be related to the dominant TCE dechlorination mechanism mediated by RL-Pd-NZVI particles in the aqueous phase (SYSTEM A) and the organic phase (SYSTEM B). In the aqueous phase, RL-Pd-NZVI is in contact with significantly larger amounts of water (1.38 moles) compared to RL-Pd-NZVI in the organic phase (0.013 moles), which could promote the degradation of TCE through the atomic hydrogen species generated at the Pd site (H₂→2H.) through the reduction of water (Fe⁰+2H⁺→Fe²⁺+H₂). However, in the organic phase a direct electron release from the Fe⁰ core may result in availability of 3 electrons for TCE degradation and formation of Fe³⁺ oxides. Another hypothesis that could explain the differences arising in the types of iron oxides formed in the aqueous and organic phases may be related to the adsorbed layer configuration of RL on Pd-NZVI. It is likely that the configuration of adsorbed RL layer in the aqueous phase (SYSTEM A) and organic phase (SYSTEM B) was dissimilar due to the oil-water interface in the latter system, which affected the oxidation processes differently and resulted in the growth of different oxides. This could also explain the TEM observations related to the physical arrangement of oxides as seen in FIGS. 7b and 7C. In SYSTEM A, the closely arranged clusters of iron oxides could be a result of a more compact configuration of RL on the Pd-NZVI, which caused oxide growth close to the nanoparticle surface.

Because Pd sites on the NZVI surface are the reactive sites, it can be envisioned that oxide growth near the Pd-NZVI surface retards the TCE access to Pd sites leading to a slowing down in the degradation rate. We observed a k_{obs} of 0.099 day⁻¹ for RL-Pd-NZVI in the aqueous phase (SYSTEM A) while in the organic phase (SYSTEM B) the RL-Pd-NZVI exhibited a higher k_{obs} of 0.413 day⁻¹ due to the relatively easier access of TCE to Pd because of growth of oxides away from the Pd-NZVI surface. The passivation of Pd-NZVI in aqueous phase reactions has not been reported in earlier studies with adsorbed polyelectrolytes or surfactant layers bound to Pd-NZVI. Under stoichiometrically excess conditions of Pd-NZVI, there is an adequate supply of electrons to degrade TCE rapidly and therefore the extent of oxide growth near the nanoparticle surfaces caused by adsorbed RL may not be sufficient enough to cause a passivation effect and adversely affect the degradation rate.

Generation of toxic end products is undesirable in the environmental remediation of TCE. Therefore, a detailed end product characterization was carried out to evaluate the possible advantages or drawbacks that degradation of TCE NAPL in the organic phase may have compared to degradation of TCE in aqueous phase.

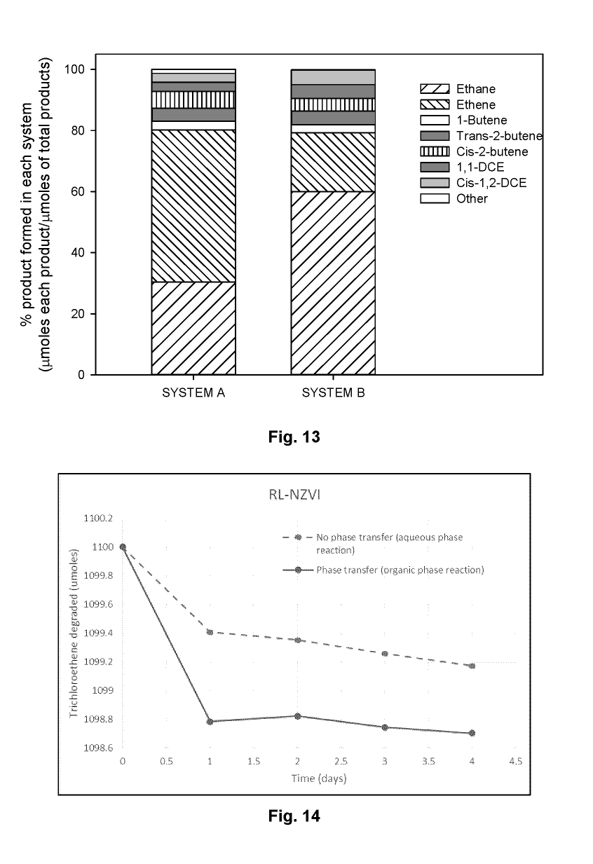

In FIG. 13, it is seen that the major end products (80%) in both systems at the end of the reactive lifetime are non-toxic ethene and ethane. Butenes, which are usually the coupling products of acetylene and ethene, make up 10% of the remaining minor products. Other minor products are provided in Table 1 and were less than 1% of the total degradation products generated. Certain differences are however observed in SYSTEM B compared to SYSTEM A. In SYSTEM B we observe that ethane and dichloroethylenes (1,1-DCE and cis-1,2-DCE) constitute higher amounts of the end products compared to SYSTEM B. For instance, the formation of slightly higher amounts of DCEs in SYSTEM B (9%) are observed compared to SYSTEM A (5%). The differences arising in the end products could be due to a shift in the preferential dechlorination pathway of certain reaction intermediates within the organic phase.

Overall, results from TCE degradation studies and end product distribution demonstrate that the phase transfer of RL-Pd-NZVI into the organic phase is an effective strategy for the degradation of TCE NAPL. RL-Pd-NZVI phase transferred into an organic phase was able to degrade 50% more TCE NAPL at a 4 fold faster rate compared to RL-Pd-NZVI in the aqueous phase. This higher efficiency of TCE transformation was achieved due to different oxide growth mechanisms resulting in the ability of RL-Pd-NZVI to provide 3 electrons in the organic phase compared to 2 electrons in the aqueous phase.

The present disclosure will be more readily understood by referring to the following examples which are given to illustrate embodiments rather than to limit its scope.

### GENERAL INFORMATION—EXPERIMENTAL

Ferrous sulfate heptahydrate (99%), sodium borohydride (98.5%), and palladium acetate (99%) were purchased from Sigma-Aldrich. Rhamnolipid JBR215 (mixture of di-rhamnolipid with M.W. 650 g mol-1 and mono-rhamnolipid with M.W. 504 g mol-1) was purchased from Jeneil Biosurfactant Co. (Saukville, Wis.). Gas standards of ethane, ethylene, methane (99% purity) and 1-, cis-, trans-butene (1000 ppm in N2) were obtained from Scotty Specialty Gases. Chloroethylenes (vinyl chloride and cis 1,2- & trans 1,2-dichloroethylene) and hexenes (cis 3- & trans 3-≥95%) were obtained from Sigma-Aldrich. Methanol and butanol (99% purity) were purchased from Fisher Scientific. Water used in experiments was Millipore double deionized water.

Bare NZVI particles were synthesized using a procedure described previously (Rajajayavel, S. R. C. et al. Water Res. 2015, 78, 144-153) which is hereby incorporated by reference. An aqueous solution of 0.07 M FeSO₄.7H₂O prepared in 30% methanol was continuously mixed with 0.019 M NaBH₄ being added drop-wise at 3 mL/min using a syringe pump, followed by a mixing time of one hour. The resulting NZVI suspension was washed three times with methanol and dried under nitrogen and stored in sealed vials in an anaerobic glove box (Coy Laboratories) containing high purity N₂/H₂ (95%:5%).

### Example I

### RL-Pd-NZVI Synthesis

40 mg dried NZVI was added in a 60 mL vial containing 18.8 mL H₂O and sonicated for 10 minutes to disperse the nanoparticles. Next, RL was coated onto NZVI by addition of 0.2 mL of 10 g/L Total Organic Carbon (TOC) RL stock to the NZVI suspension and mixing on a table top shaker at 300 rpm at 25±1° C. for 20 hours (RL-NZVI). After 20 hours, a 0.4 mL ethanolic solution of 1 g/L of Pd-Acetate was added to the RL-NZVI and sonicated for 10 minutes to synthesize RL-Pd-NZVI (Pd(O₂CCH₃)₂=1 wt. % of NZVI).

In reactivity studies with non-phase transferred RL-Pd-NZVI, 5.5 mL H₂O was added to the vial after the RL-Pd-NZVI preparation followed by 0.1 mL pure TCE.

For phase transferred systems, the following protocol was implemented after the RL-Pd-NZVI preparation.

### Example II

### Phase Transfer Protocol and Reactivity Studies

0.1 mL of pure TCE was then added to the RL-Pd-NZVI suspension which resulted in the formation of an immiscible oil phase at the bottom of the vial. Thereafter, 4 mL of butanol was added, resulting in a clear separate phase at the top of the aqueous solution. All of the components were then subjected to sonication for 10 min (37 kHz frequency, FisherBrand 11203 Ultrasonicator) which created a grayish-black suspension. Finally, 1.5 mL of NaCl (6M stock) was added to initiate the phase separation and transfer of nanoparticles into the organic phase which occurred within 10 minutes.

TCE degradation experiments were carried out in 60 mL vials capped with crimp-sealed butyl rubber septa and samples were prepared in the anaerobic glove box. Degradation products were quantified periodically by injection of 300 μL reactor headspace into a Varian CP 3800 GC with flame ionization detector fitted with a GS-Q plot column (0.53 mm×30 m, Agilent). Samples were injected in split-less mode at 250° C. injector temperature and oven temperature held at 50° C. for 2 min, followed by a ramp of 40° C./min to 200° C. and then held at that temperature for 5 min. Reaction end products were identified in a GC-MS analyses (Clarus SQ-8, Perkin Elmer) of headspace samples. 300 μL reactor headspace was injected in split mode (20 mL/min) into the GC-MS fitted with GS-Q plot column (0.32 mm×30 m) while other run parameters were similar to the GC-FID program.

Due to NAPL quantities of TCE used in the study, tracking the TCE disappearance with time was not feasible. Therefore, reaction end products were quantified at each intermediate time point and a carbon mass balance approach was used to obtain the corresponding TCE degraded. Calibration standards were prepared by adding known quantities of the gas standard in the reactors set-up exactly like SYSTEM A and B, but without the Pd-NZVI.

The TOC content of RL was determined using a TOC analyzer (Shimadzu Corp.) and 1 g/L TOC corresponds to 1.7 g/L mass concentration of RL.

The mass of RL adsorbed to the NZVI surface was estimated by measuring the difference between the unadsorbed RL in solution after equilibration (i.e., 20 h mixing period between NZVI and RL) and the total RL dose. The NZVI was separated by centrifugation (6500 g, 20 min) and then retained in a vial by the use of a super magnet (K&J Magnetics Inc.) while the supernatant was decanted and analyzed. All of the RL was found to be adsorbed to NZVI.

The mass of Pd deposited on NZVI particles was measured using an ICP-OES (Thermo ICap Duo 6500). The RL-Pd-NZVI was separated from solution using centrifugation followed by magnetic separation and then the nanoparticles and the supernatant were separately acid digested in aqua regia (3:1 HCl:HNO₃). Pd deposited on NZVI was 0.5% w/w NZVI.

Fe⁰ content was measured using an acid digestion protocol. The NZVI particles were acid digested in HCl and the liberated H₂ gas was measured using a GC-TCD.

XPS was performed for nanoparticles using a VG Escalab 3MKII instrument. Prior to measurement, the samples were dried in an anaerobic chamber. Samples were irradiated using an Al Kα source at a power of 300 W (15 kV, 20 mA). The binding energies of the photoelectrons were calibrated by the aliphatic adventitious hydrocarbon C 1s peak at 285.0 eV with survey scan of energy step of 1.0 eV, pass energy of 100 eV, and high resolution scans with energy step of 0.05 eV, pass energy of 20 eV.

Transmission electron microscopy (TEM) was performed on nanoparticles using a Tecnai G2F20 S/TEM, operated at 200 kV. The machine is equipped with Gatan Ultrascan 4000 4 k×4 k CCD Camera and Model 895 EDAX Octane T Ultra W/Apollo XLT2 SDD and TEAM EDS Analysis System. A drop of the samples was directly placed on copper TEM grids and dried using KimWipe® before being analyzed. Optical microscopy images were obtained using an Olympus BX51 microscope.

The aqueous and organic phases after the phase transfer process were characterized on a mass basis, in the absence of Pd-NZVI. Each step of the phase transfer protocol was replicated in a 25 mL vial to minimize losses to headspace. The difference in the mass of the vial was noted after the addition of each component. After the phase separation was completed, the aqueous phase was carefully removed and placed in a 60 mL vial. Based on the air/water partitioning of TCE, butanol, and ethanol, concentrations in the aqueous phase were determined through headspace measurements in GC-FID. Using a conductivity meter (Fisher Scientific Traceable™ Conductivity Meter), the salt concentration was determined in the aqueous phase. Water content in the organic phase was measured using a Karl-Fischer coulometric titrator (Mettler Toledo C30 Compact Karl Fischer Coulometer).

### Example III

### RL-NZVI Synthesis

40 mg dried NZVI was added in a 60 mL vial containing 19.2 mL H₂O and sonicated for 10 minutes to disperse the nanoparticles. Next, RL was coated onto NZVI by addition of 0.2 mL of 10 g/L Total Organic Carbon (TOC) RL stock to the NZVI suspension and mixing on a table top shaker at 300 rpm at 25±1° C. for 20 hours (RL-NZVI).

In reactivity studies with non-phase transferred RL-NZVI, 5.5 mL H₂O was added to the vial after the RL-NZVI preparation followed by 0.1 mL pure TCE.

For phase transferred systems, the following protocol was implemented after the RL-NZVI preparation.

### Example IV

### Phase Transfer Protocol and Reactivity Studies

0.1 mL of pure TCE was then added to the RL-NZVI suspension which resulted in the formation of an immiscible oil phase at the bottom of the vial. Thereafter, 4 mL of butanol was added, resulting in a clear separate phase at the top of the aqueous solution. All of the components were then subjected to sonication for 10 min (37 kHz frequency, FisherBrand 11203 Ultrasonicator) which created a grayish-black suspension. Finally, 1.5 mL of NaCl (6M stock) was added to initiate the phase separation and transfer of nanoparticles into the organic phase which occurred within 10 minutes.

TCE degradation experiments were carried out in 60 mL vials capped with crimp-sealed butyl rubber septa and samples were prepared in the anaerobic glove box. Degradation products were quantified periodically by injection of 300 μL reactor headspace into a Varian CP 3800 GC with flame ionization detector fitted with a GS-Q plot column (0.53 mm×30 m, Agilent). Samples were injected in split-less mode at 250° C. injector temperature and oven temperature held at 50° C. for 2 min, followed by a ramp of 40° C./min to 200° C. and then held at that temperature for 5 min. Reaction end products were identified in a GC-MS analyses (Clarus SQ-8, Perkin Elmer) of headspace samples. 300 μL reactor headspace was injected in split mode (20 mL/min) into the GC-MS fitted with GS-Q plot column (0.32 mm×30 m) while other run parameters were similar to the GC-FID program.

Due to NAPL quantities of TCE used in the study, tracking the TCE disappearance with time was not feasible. Therefore, reaction end products were quantified at each intermediate time point and a carbon mass balance approach was used to obtain the corresponding TCE degraded. Calibration standards were prepared by adding known quantities of the gas standard in the reactors set-up exactly like SYSTEM A and B, but without the NZVI.

As shown in FIG. 14, a 2 times improvement in TCE degradation rate and 25% improvement in TCE degradation extent is observed in the organic phase compared to the aqueous phase.

The TOC content of RL, the mass of RL adsorbed to the NZVI surface, the mass of Pd deposited on NZVI particles, the Fe⁰ content, the XPS and TEM analysis were all conducted as described in Example II above.

While the disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

All references cited herein are incorporated by reference in their entirety.

1. A process for degrading an amount of halogenated solvent by chemical reduction reactions in a non-aqueous phase liquid NAPL, comprising:
forming an oil in water emulsion of said halogenated solvent with an aqueous suspension comprising nanoscale zerovalent iron (NZVI) particle coated by a rhamnolipid (RL-NZVI), or NZVI functionalized with other materials (M) to improve its reactivity, and coated by a rhamnolipid (RL-M-NZVI) and a water-immiscible non-halogenated organic solvent; and
adding a water soluble, non-toxic salt thereby forming a water in oil emulsion and reacting said TCE and said RL-NZVI or RL-M-NZVI.

2. (canceled)

3. (canceled)

4. The process of claim 1, wherein said material M is palladium.

5. A process for degrading an amount of halogenated solvent by chemical reduction reactions in a non-aqueous phase liquid NAPL, comprising:
suspending a nanoscale zerovalent iron (NZVI) particle coated by a rhamnolipid (RL-NZVI), or a palladium doped nanoscale zerovalent iron (Pd-NZVI) particle coated by a rhamnolipid (RL-Pd-NZVI) in an aqueous medium of a system comprising a water-immiscible non-halogenated organic solvent and said aqueous medium;
forming an oil in water emulsion comprising said halogenated solvent, said RL-Pd-NZVI or RL-NZVI and water-immiscible non-halogenated organic solvent; and
adding a water soluble, non-toxic salt thereby forming a water in oil emulsion, and reducing said amount of halogenated solvent.

6. The process of claim 1, wherein the halogenated solvent is perchloroethene (PCE) or trichloroethene (TCE).

7. (canceled)

8. The process of claim 1, wherein said rhamnolipid (RL) is comprising one or two rhamnose moieties (glycon), and one or two β-hydroxy fatty acid moieties (aglycon), and wherein the β-hydroxy fatty acid chains are saturated, mono-, or poly-unsaturated and of chain length varying from C₈ to C₁₆.

9. The process of claim 8, wherein said rhamnolipid (RL) is 2-O-rhamnopyranosyl-rhamnopyranosyl-3-hydroxyldecanoyl-3-hydroxydecanoate or rhamnopyranosyl-3-hydroxyldecanoyl-3-hydroxydecanoate or a mixture thereof.

10. The process of claim 1, wherein said water-immiscible non-halogenated organic solvent is n-butanol, ethyl acetate, pentanol, hexanol or octanol or a mixture thereof.

11. (canceled)

12. The process of claim 1, wherein said water soluble, non-toxic salt is NaCl, Na₂CO₃, CaCl₂, or MgCl₂.

13. (canceled)

14. The process of claim 5, for degrading an amount of trichloroethene (TCE) or perchloroethene (PCE) by chemical reduction reactions in a non-aqueous phase liquid NAPL, comprising:
suspending a nanoscale zerovalent iron coated by a rhamnolipid and doped with palladium (RL-Pd-NZVI) in an aqueous medium of a system comprising a water-immiscible non-halogenated organic solvent and said aqueous medium;
forming an oil in water emulsion comprising said TCE or perchloroethene (PCE), said RL-M-NZVI and water-immiscible non-halogenated organic solvent; and
adding a water soluble, non-toxic salt thereby forming a water in oil emulsion, and reducing said amount of TCE;
wherein said rhamnolipid is a 2-O-rhamnopyranosyl-rhamnopyranosyl-3-hydroxyldecanoyl-3-hydroxydecanoate and/or rhamnopyranosyl-3-hydroxyldecanoyl-3-hydroxydecanoate, said water-immiscible non-halogenated organic solvent is n-butanol, ethyl acetate, pentanol, hexanol or octanol, said water soluble, non-toxic salt is NaCl, Na₂CO₃, CaCl₂, or MgCl₂.

15. The process of claim 14, for degrading TCE.

16. (canceled)

17. A process for producing a doped nanoscale zerovalent iron particle coated with a rhamnolipid (RL-M-NZVI), the process comprising:
a) providing an aqueous dispersion of nanoscale zerovalent iron particle (NZVI);
b) contacting said dispersion of NZVI with a rhamnolipid (RL) to provide a rhamnolipid-coated nanoscale zerovalent iron (RL-NZVI); and
c) depositing a doping material (M), on said RL-NZVI of step b) to provide said doped RL-M-NZVI.

18. The process of claim 17, wherein said rhamnolipid (RL) is comprising one or two rhamnose moieties (glycon), and one or two β-hydroxy fatty acid moieties (aglycon), and wherein the β-hydroxy fatty acid chains are saturated, mono-, or poly-unsaturated and of chain length varying from C₈ to C₁₆.

19. The process of claim 17, wherein said rhamnolipid (RL) is 2-O-rhamnopyranosyl-rhamnopyranosyl-3-hydroxyldecanoyl-3-hydroxydecanoate or rhamnopyranosyl-3-hydroxyldecanoyl-3-hydroxydecanoate or a mixture thereof.

20. The process of claim 5, wherein the halogenated solvent is perchloroethene (PCE) or trichloroethene (TCE).

21. The process of claim 5, wherein said rhamnolipid (RL) is comprising one or two rhamnose moieties (glycon), and one or two β-hydroxy fatty acid moieties (aglycon), and wherein the β-hydroxy fatty acid chains are saturated, mono-, or poly-unsaturated and of chain length varying from C₈ to C₁₆.

22. The process of claim 21, wherein said rhamnolipid (RL) is 2-O-rhamnopyranosyl-rhamnopyranosyl-3-hydroxyldecanoyl-3-hydroxydecanoate or rhamnopyranosyl-3-hydroxyldecanoyl-3-hydroxydecanoate or a mixture thereof.

23. The process of claim 5, wherein said water-immiscible non-halogenated organic solvent is n-butanol, ethyl acetate, pentanol, hexanol or octanol or a mixture thereof.

24. The process of claim 5, wherein said water soluble, non-toxic salt is NaCl, Na₂CO₃, CaCl₂, or MgCl₂.

25. The process of claim 17, wherein said material M is palladium.

26. The process of claim 17, wherein said rhamnolipid (RL) is comprising one or two rhamnose moieties (glycon), and one or two β-hydroxy fatty acid moieties (aglycon), and wherein the β-hydroxy fatty acid chains are saturated, mono-, or poly-unsaturated and of chain length varying from C₈ to C₁₆.

27. The process of claim 26, wherein said rhamnolipid (RL) is 2-O-rhamnopyranosyl-rhamnopyranosyl-3-hydroxyldecanoyl-3-hydroxydecanoate or rhamnopyranosyl-3-hydroxyldecanoyl-3-hydroxydecanoate or a mixture thereof.
